(19) United States
(12) Patent Application Publication
(10) Pub. No.: US 2025/0103944 A1
(43) Pub. Date: Mar. 27, 2025

(54) SYSTEMS AND METHODS FOR GENERATING NATURAL SOLUTIONS TO A DESIGN TASK BY A LEARNING MODEL

(71) Applicant: Toyota Research Institute, Inc., Los Altos, CA (US)

(72) Inventors: Hyeonsu B. Kang, Pittsburgh, PA (US); Chuan-En Lin, Pittsburgh, PA (US); Nikolas A. Martelaro, Pittsburgh, PA (US); Aniket D. Kittur, Pittsburgh, PA (US); Yin-Ying Chen, San Jose, CA (US); Matthew K. Hong, Mountain View, CA (US)

(73) Assignees: Toyota Research Institute, Inc., Los Altos, CA (US); Toyota Jidosha Kabushiki Kaisha, Toyota-shi Aichi-ken (JP); Carnegie Mellon University, Pittsburgh, PA (US)

(21) Appl. No.: 18/423,928

(22) Filed: Jan. 26, 2024

Related U.S. Application Data
(60) Provisional application No. 63/585,760, filed on Sep. 27, 2023.

(51) Int. Cl. G06N 20/00

(52) U.S. Cl. CPC G06N 20/00

(57) ABSTRACT

Systems, methods, and other embodiments described herein relate to identifying and generating mechanisms from natural processes by a learning model for accelerating design development. In one embodiment, a method includes identifying mechanisms for a design task using a prompt transformer with seeds from biological processes, and the prompt transformer forms a taxonomy tree using the mechanisms. The method also includes generating functional solutions that expand sparse branches of the taxonomy tree for the mechanisms using the prompt transformer. The method also includes clustering the mechanisms using text embedding for the design task. The method also includes inspecting the mechanisms with the prompt transformer to select a solution associated with the design task.

### CROSS-REFERENCE TO RELATED APPLICATIONS

This application claims the benefit of U.S. Provisional Application No. 63/585,760, filed on, Sep. 27, 2023, which is herein incorporated by reference in its entirety.

### TECHNICAL FIELD

The subject matter described herein relates, in general, to assisting a design task by a learning model, and, more particularly, to identifying and generating mechanisms from natural processes by the learning model for accelerating design development.

### BACKGROUND

Systems can train a learning model to perform tasks when training data is robust. For example, a large language model (LLM) is a learning model that a system trains to solve a problem associated with a task through text prompts. However, complex tasks and problems can demand data curated by experts, which may be prohibitively expensive and sparse. Furthermore, LLMs generating solutions at times lack diversity and creativity when relating a problem associated with a task to uncommon solutions.

In various implementations, nature is an inspirational source for solutions to design and development tasks that are complex. Systems exploring natural domains involve analogical computations that encompass discovering and recognizing structural similarities between source and target analogs. Still, natural-analogical inspirations for engineering and design domains encounter difficulties associated with limited data and manual tasks. Furthermore, a LLM generating analogies for bio-inspired designs can have limited diversity even when tuning and adapting parameters. Therefore, systems implementing a learning model that derives solutions for complex design tasks from natural mechanisms encounter difficulties associated with manual controls and data scarcity.

### SUMMARY

In one embodiment, example systems and methods relate to identifying and generating mechanisms from natural processes by a learning model for accelerating design development. In various implementations, systems implement a large language model (LLM) that is trained to solve design tasks (e.g., a vehicle defect) by exploring functional mechanisms through text prompts. Functional mechanisms can be natural phenomena that share an analogous problem-solution with a design problem. As such, these systems generate prompts that are knowledge-augmented and facilitate a design space that is different than discrete-level manipulation. However, designers exploring a source of natural analogies can encounter difficulties with understanding and identifying viable solutions to a task. For example, cognitive biases towards surface similarity and working memory limitations impede mappings between biological and engineering systems. Furthermore, implementing found analogies within the constraints and scope of a design problem adds complexity for design development.

Therefore, in one embodiment, a design system implements a learning model having an analogy pipeline for solving a design task using natural processes that are scalable, reduce expert-curation costs, and improve the limitations of generative learning. In particular, the design system may explore a design space for constructing a mechanisms dataset that is diverse through modular and structured knowledge augmentation. For example, the mechanisms are biological processes from organisms having analogous problems and solutions with the design task. Furthermore, the design system generates an interface for interactively recognizing the relevance and the adaptability of analogs for the design task. In this way, the design system accelerates development cycles by augmenting ideations through multimodal sources for searching natural analogics at scale and adapting the analogics, thereby inspiring engineering designs that are increasingly unique.

In various implementations, the design system identifies mechanisms for a design problem using seeds (e.g., biological processes) with a prompt transformer and expands the mechanisms through a taxonomic tree that is constructed iteratively. In this way, the design system overcomes data sparsity of expert curation from manual sources. The design system also increases conceptual diversity occasionally lacking from analogies automatically generated by a LLM. Furthermore, the interface can increase mechanism diversity and adaptation through functions such as explain, compare, and combine. Accordingly, the prompt transformer and interface allow an end-to-end approach for real-time interaction with natural mechanisms analogous with a design task and facilitate interactive learning with new mechanisms, thereby improving ideation and object design.

In one embodiment, a design system for identifying and generating mechanisms from natural processes by a learning model to accelerate design development is disclosed. The design system includes a memory storing instructions that, when executed by a processor, cause the processor to identify mechanisms for a design task using a prompt transformer with seeds from biological processes, and the prompt transformer forms a taxonomy tree using the mechanisms. The instructions also include instructions to generate functional solutions that expand sparse branches of the taxonomy tree for the mechanisms using the prompt transformer. The instructions also include instructions to cluster the mechanisms using text embedding for the design task. The instructions also include instructions to inspect the mechanisms with the prompt transformer to select a solution associated with the design task.

In one embodiment, a non-transitory computer-readable medium for identifying and generating mechanisms from natural processes by a learning model to accelerate design development and including instructions that when executed by a processor cause the processor to perform one or more functions is disclosed. The instructions include instructions to identify mechanisms for a design task using a prompt transformer with seeds from biological processes, and the prompt transformer forms a taxonomy tree using the mechanisms. The instructions also include instructions to generate functional solutions that expand sparse branches of the taxonomy tree for the mechanisms using the prompt transformer. The instructions also include instructions to cluster the mechanisms using text embedding for the design task. The instructions also include instructions to inspect the mechanisms with the prompt transformer to select a solution associated with the design task.

In one embodiment, a method for identifying and generating mechanisms from natural processes by a learning model to accelerate design development is disclosed. In one embodiment, the method includes identifying mechanisms for a design task using a prompt transformer with seeds from biological processes, and the prompt transformer forms a taxonomy tree using the mechanisms. The method also includes generating functional solutions that expand sparse branches of the taxonomy tree for the mechanisms using the prompt transformer. The method also includes clustering the mechanisms using text embedding for the design task. The method also includes inspecting the mechanisms with the prompt transformer to select a solution associated with the design task.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a design system within which systems and methods disclosed herein may be implemented.

FIG. 2 illustrates embodiments of the design system that are associated with identifying mechanisms for a design task from nature and expanding a taxonomy tree including the mechanisms.

FIGS. 3A and 3B illustrate embodiments of the design system generating an interface for interactively recognizing relevant mechanisms and adapting analogic mechanisms for the design task.

FIG. 4 illustrates one embodiment of a method that is associated with identifying mechanisms for a design task within a taxonomical framework and generating mechanisms that can be functional solutions that expand sparse branches using a prompt transformer.

### DETAILED DESCRIPTION

Systems, methods, and other embodiments associated with identifying and generating mechanisms from natural processes by a learning model for accelerating design development are disclosed herein. In various implementations, systems assisting design tasks by suggesting solutions to a design problem encounter difficulties with diversity and creativity. For example, prompting a large language model (LLM) to generate a design for a vehicle hood having reduced air resistance outputs limited solutions with expertly-curated data that is scarce. In another example, systems explore natural domains for analogical processing that encompasses locating structural similarities between domains. Here, an analog may be an engineering and natural mechanism having a similar purpose (i.e., “solving what problem”) with diverse mechanisms (i.e., “how to solve the problem”), thereby leading to creative solutions. Still, natural-analogical inspirations for engineering and design domains can be biased toward organisms that are well-known and common. These systems can also demand humans intensively sifting through sources that are vast and fragmented (e.g., wikipedia). Databases curated by human-experts for streamlining searches can be costly to assemble and exhibit data scarcity, thereby limiting mechanisms available for making analogies. Furthermore, automatic generation of analogies with a LLM that creates datasets for bio-inspired designs have limited diversity about abstract concepts even when tuning parameters, such as through logic suppression. As such, a learning model exploring analogs can be limited by existing designs and scarce data, thereby hindering creativity.

Therefore, in one embodiment, a design system identifies a mechanism dataset with a prompt transformer for a design task using seeds acquired from a source having natural processes (e.g., AskNature, DANE, SAPPHIRE, BioTRIZ, etc.). The design system generates mechanisms that expand sparse branches of a taxonomy tree formed with the mechanism dataset. Here, a prompt transformer may iteratively construct taxonomic hierarchies of organisms and diversify using knowledge prompts that are breadth-focused and depth-focused. For example, the prompt transformer computationally traverses the taxonomy tree to add a new genus and augment an existing genus at sparse branches for the design problem. Furthermore, the design system may organize the mechanisms through clustering using text embedding, such as according to semantics (e.g., context, categories, sentiment, etc.).

Moreover, in another embodiment, the design system generates an interface with interactive functions that support task learning and solution synthesis. Here, the interface assists designers with recognizing and understanding relevant analogs to design tasks and problems. For example, the interactive functions include one of explaining, comparing, combining, and critiquing functions. The explain function can guide designers to understand the details and relevance associated with an analog. The compare function facilitates a comparative understanding of mechanisms (e.g., pros and cons). Furthermore, the combine function aids in the generative ideation of multiple analogs while the critique function assists with design iterations and engineering through feedback. In this way, the design system allows inspecting the mechanisms with the prompt transformer to select a solution associated with the design task. Accordingly, the design system identifies and generates mechanisms from natural processes for a design task with a prompt transformer that increases solution breadth, creativity, and diversity.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

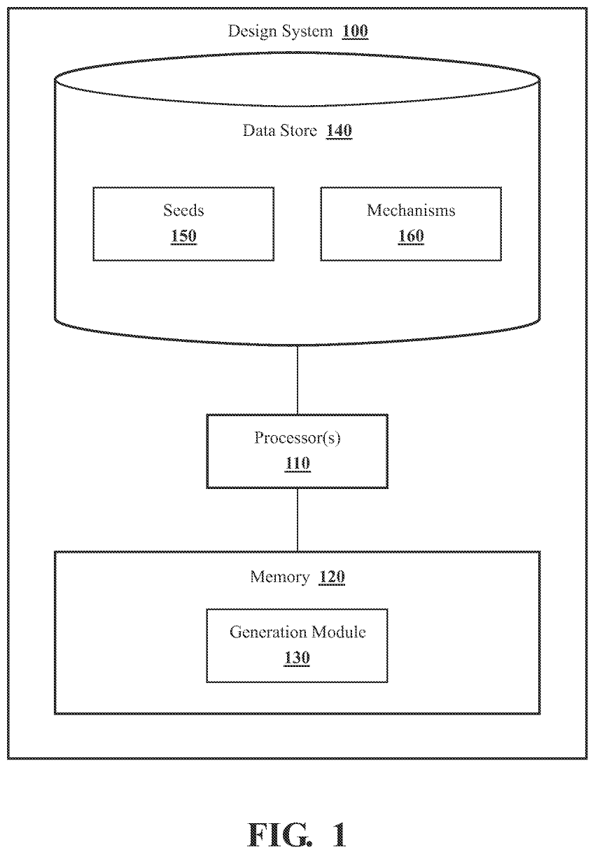

Referring to FIG. 1, one embodiment of the design system 100 is illustrated. The design system 100 is shown as including a processor(s) 110. The design system 100 may access the processor(s) 110 through a data bus or another communication path. In one embodiment, the design system 100 includes a memory 120 that stores a generation module 130. The memory 120 is a random-access memory (RAM), a read-only memory (ROM), a hard-disk drive, a flash memory, or other suitable memory for storing the generation module 130. The generation module 130 is, for example, computer-readable instructions that when executed by the processor(s) 110 cause the processor(s) 110 to perform the various functions disclosed herein.

In various implementations, the design system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the generation module 130 in executing various functions. In one embodiment, the data store 140 includes the seeds 150 and the mechanisms 160. In one approach, the seeds 150 are data pairs having organisms and mechanisms with functional and aesthetic characteristics that are analogical for a design task. The design system 100 can acquire the seeds 150 for a design task from sources of expertly-curated data that has quality and diversity, such as sources AskNature, DANE, SAPPHIRE, BioTRIZ, etc. As explained in detail below, the mechanisms 160 may be biological functions of organisms that may have analogies with a design task.

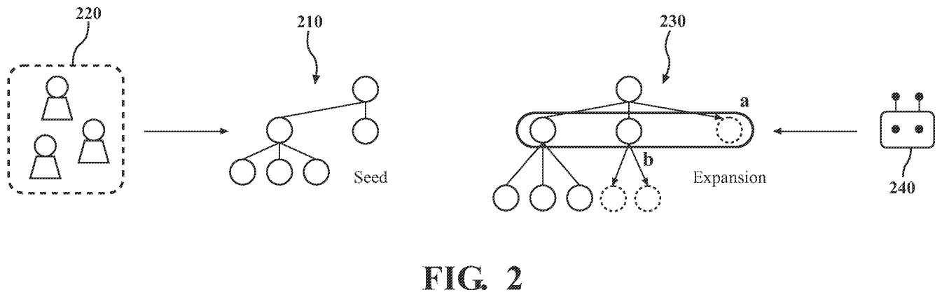

FIG. 2 illustrates embodiments of the design system 100 that is associated with identifying mechanisms for a design task from nature and expanding a taxonomy tree having the mechanisms. The generation module 130, in one embodiment, includes instructions that cause the processor(s) 110 to generate and expand mechanisms from the seeds 210 identified by the design system 100. Initially, the design system 100 may identify mechanisms for a design task using a prompt transformer with the seeds 210 from biological processes and the prompt transformer forms the taxonomy tree 230 from the mechanisms. Although certain examples herein implement a prompt transformer, the design system 100 may implement any LLM for identifying and generating mechanisms from natural processes associated with a design task. For example, the design system 100 instructs the prompt transformer (e.g., generative pre-trained transformer 4 (GPT-4)) to structure data from human experts 220 (e.g., AskNature posts, AskNature images, etc.) that is raw into problem-mechanism schemas. Here, the data can be a curated list of organisms with detailed descriptions facilitating unique strategies to functional problems (e.g., manage impact, modify speed, etc.). The organisms and strategies can be grouped by function and viewed as a list. To curate the seeds 210 towards quality mechanisms, the design system 100 may predict a functional problem p that is relevant to a domain (e.g., automobile designers) and exclude irrelevant functions such as adapt behaviors, adapt genotype, co-evolve, maintain community, etc. The design system 100 can search a sub-list of organisms o∈O and strategies to p from the human experts 220 through a group-by-function feature by parsing web code (e.g., hypertext markup language (HTML) code). The design system 100 accesses the data from the human experts 220 for an organism-strategy using parsed universal resource locators (URL) and parses the returned web page for acquiring the title, description, and references as unstructured text.

Additionally, the design system 100 organizes the unstructured text that is raw into a mechanism description using the prompt transformer 240 associated with the generation module 130. Here, the prompt transformer 240 can select a functional problem from the biological processes associated with a design task, access a subset of organisms associated with the functional problem, and structure the subset by textually describing the mechanisms. For example, the prompt transformer 240 compactly describes an identified mechanism of a data pair (o, p) having raw text and missing information related to the design task. In another approach, the prompt transformer 240 outputs a description of the mechanism when having complete information from the human experts 220 with input (o, p, Experts(o, p)). Regarding scenarios involving incomplete information, the mechanism description m outputted along with the function description may be a problem-mechanism schema for an organism: {o∈O|(p, m, o)}.

Moreover, the design system 100 traverses the taxonomy tree 230 using the prompt transformer 240 to add a new genus a and augment an existing genus b at the sparse branches for the design task, such as with the seeds 210. For example, the design system 100 iteratively invokes the prompt transformer 240 to identify and generate relevant mechanisms for an inputted mechanism and problem using the problem-mechanism schemas as seeds. Here, the taxonomy tree 230 can expand by mixing breadth-focused and depth-focused strategies. At an iteration, the design system 100 constructs the taxonomy tree 230 using organisms represented in the generated mechanisms up to that point. The prompt transformer 240 extracts sibling taxonomies at a tree node for breadth-focused expansion with the new genus a. Depth-focused expansion of children taxonomies is executed on the existing genus b.

In one approach, an expansion strategy includes appending extracted taxonomies to a prompt as constraints (e.g., “come up with a few biological classes not in { . . . names of excluded classes . . . }”). For example, breadth-focused expansion includes the system specifying the taxonomic level of generation (e.g., “biological classes”) and appending extracted taxonomies to a prompt as exclusion constraints. For depth-focused expansion, the system further specifies a parent taxon for generation in the prompt (e.g., “come up with a few biological families in the order araneae”) that can include exclusion constraints added to the prompt, thereby preventing generating already extracted taxons.

An expansion may continue and follow multiple levels of a natural hierarchy: {domain, kingdom, phylum, class, order, family, genus, species} where a domain represents the highest level and a species represents the lowest level on the hierarchy. The design system 100 focuses on species subparts for a relevant mechanism (e.g., adhesive paws of geckos, hierarchical layers in pomelo peels, etc.). Furthermore, the design system 100 can cut the taxonomy tree 230 at a level (e.g., class) for expansion and sort taxonomies (e.g., nodes) on the level by children nodes that are immediately in increasing order. Alternatively, the complete subtree is sorted rather than immediate children when computational resources are available.

For computational efficiency, the design system 100 may batch prompts for expansion by the prompt transformer 240. In one approach, the prompt transformer 240 increases the mechanisms within a section of the taxonomy tree 230 for a non-existing genus using a first prompt(s). Next, the prompt transformer 240 expands outside the section of the taxonomy tree 230 for an existing genus using a second prompt(s). This expansion includes adding mechanisms proximate to the existing genus. For example, the prompt transformer 240 first expands selected prompts with breadth-focused expansion focused at a taxon level and existing nodes up to a predetermined amount (e.g., 50). Here, the prompt can ask “come up with a few biological classes not in { . . . names of excluded classes . . . }.” The breadth-focused expansion instructs the prompt transformer 240 to repeat the following: 1) select a taxon from a list identified; and 2) compactly describe (e.g., 14 words or less) new mechanisms m associated with a problem p.

For the non-selected prompts, the prompt transformer 240 can expand existing children nodes randomly sampled and a new child node at a taxon level using the depth-focused expansion. For example, the prompt asks “explore a few biological families in order araneae that are not any of {araneidae, . . . }.” In one approach, the depth-first expansion is followed by a breadth-focused expansion as further development. In this way, the design system 100 generates mechanisms efficiently from natural processes that expand solutions and the mechanisms within the taxonomy tree 230 through prompt batching that is strategic.

Regarding further organization, the design system 100 may convert text strings of mechanisms within the taxonomy tree 230 to numerical vectors using an embedding model (e.g., k-means) for clustering. The numerical vectors allow the design system 100 to compare and derive semantic relationships of the text strings associated with the mechanisms. A semantic relationship can include a label indicating frequent unigrams (e.g., lower-case words) appearing in mechanism texts, excluding stopwords. Furthermore, the design system 100 can derive word frequency associated with the mechanisms by counting word frequency and selecting the top x frequent words as a cluster description. In this way, clustering provides a diverse look at mechanisms for design and increases efficiency.

In various implementations, the design system 100 intelligently processes an existing dataset {∀ᵢ(pᵢ, mᵢ, oᵢ)} and identifies similar mechanisms mᵢ in (pᵢ, mᵢ, oᵢ) and mⱼ in (pⱼ, mⱼ, oⱼ). These mechanisms can be mapped to disparate problems: mᵢ˜mⱼ→pᵢ, pⱼ. Upon formulating the enriched dataset {∀ᵢ|mᵢ→S(mᵢ)}, the design system 100 expands queries for problem text through constructing a similarity search index with text embedding. Here, S(mᵢ) denotes a set of design tasks applicable to mᵢ. In this way, the design system 100 improves solution robustness for a design task through searching for analogous mechanisms in unexplored areas.

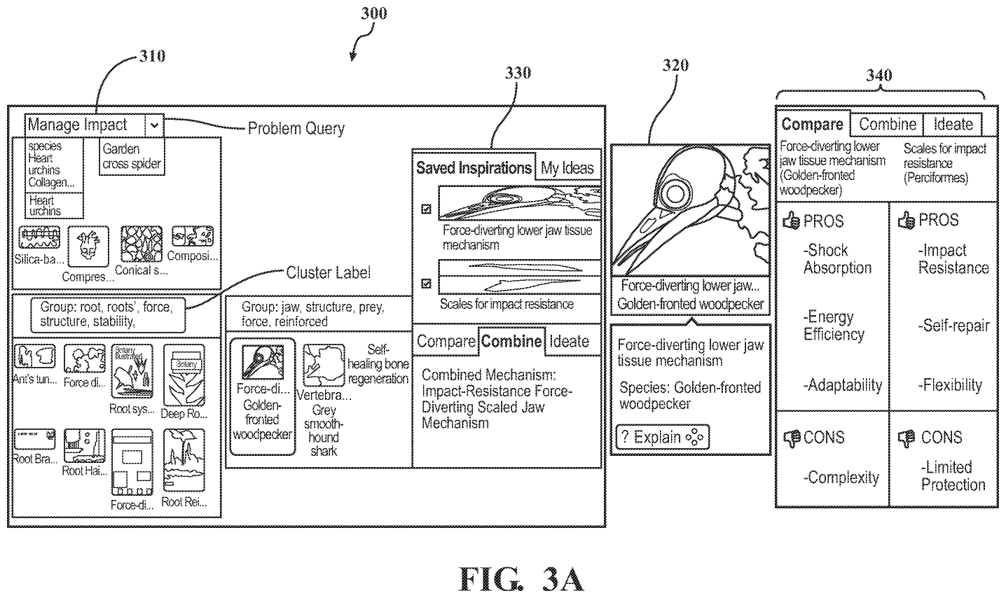

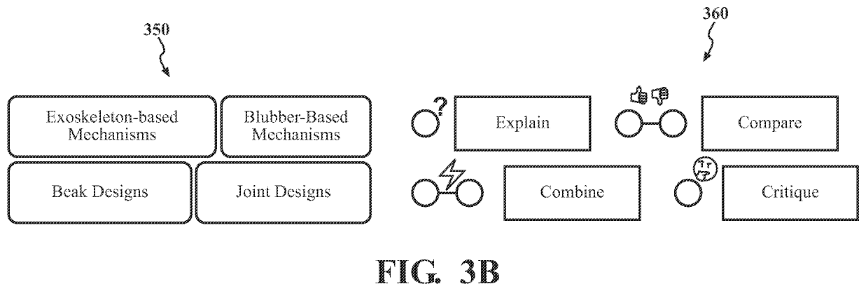

Now turning to FIGS. 3A and 3B, embodiments of the design system 100 generating an interface 300 for interactively recognizing relevant mechanisms and adapting analogic mechanisms for the design task are illustrated. For example, the design system 100 renders an interface 300 that displays textual explanations and visual representations of the mechanisms once a problem query 310 is inputted. As further explained below, the prompt transformer 240 after inspection may receive a request to revise the mechanisms from the interface 300 and revises the mechanisms through selective combinations according to functional similarities.

In the interface 300, the design system 100 aids visual understanding and increases curiosity for biological-analogical mechanisms through acquiring representative images associated with mechanism descriptions. For example, a query “[organism name]: [mechanism description]” in a search engine (e.g., Google) returns representative images. An image card with a heading may represent a mechanism and the design system 100 groups mechanisms by the headings. In various implementations, the interaction and adaptation of the analogic mechanism include one of the following functions: explain, compare, combine, and critique. The explain function 320 can request the prompt transformer 240 to expand details about a mechanism and the organism that is clustered within the context of a design task. The interface 300 can display the explanation from a mouse-over that triggers the explain function 320.

Additionally, the area 330 can include the compare function and the combine function. Here, the prompt transformer 240 can compare mechanism cards and output 340 having detailed pros and cons between multiple mechanisms within the context of the design task. Regarding mechanism combinations, the prompt transformer 240 combines mechanism cards within the context of the design task and saves the combinations as inspirations. In one approach, the combined output includes a markdown page using section titles and headers for demarcating the content. Furthermore, an ideate section can include the critique function. The ideate tab may be a rich text editor that receives additional details about the design and constructive feedback. In this way, the prompt transformer 240 receives content from the text editor describing the idea and requests additional revisions that may improve the quality, such as reducing failures and increasing improvements.

Regarding FIG. 3B, a grouping 350 represents mechanisms outputted about a design task for managing collision impact of a vehicle. Here, the grouping 350 includes exoskeleton-based mechanisms, blubber-based mechanisms, beak designs, and joint designs. The functions 360 can facilitate interactions and revisions of the mechanisms through explanations, comparisons, combinations, and critiquing. As such, a solution for managing the collision impact can be modeling a bumper structure according to mechanisms that absorb impact by a turtle shell and woodpecker beak.

Moreover, in another example, a design task is a bike rack for sedans. The design system 100 receives core challenges of securing the bike rack as turbulence management, varying wind resistance due to vehicle speed, weather conditions (e.g., precipitation), etc. A manage turbulence query to the design system 100 returns a cluster of analogical mechanisms that is diverse, such as “adaptive shape-shifting mechanism in intertidal microalgae” and “friction-based attachment mechanism of parasitic copecods.” These are disparate mechanisms that are commonly observed in organisms that live underwater. Shape-shifting microalgae adaptively reconfigure surface shapes for reducing resistance from strong currents when exposed to turbulence cues. As such, an inspiration for the design task is adaptively “lying down” bike racks on the vehicle roof to reduce air drag. Another solution is a “tail basement” bike rack mimicking motion of a bird tail. The tail basement can attach to the vehicle trunk or tailgate joining the rotational axis of the front wheel from a bike, thereby adjusting during turbulence by flexibly (counter-)swinging a bike.

The design system 100 may generate visual representations of geometries that are related to the disparate mechanisms from various orientations. For example, the interface 300 displays orientations including {up, down, front, rear, left, right, internal, external}. Enumerating these geometries visually assists a design task through effectively reviewing geometries. The visualization also facilitates imagination and ideation for alternative geometries.

The designing can continue by invoking the combine function to experimentally integrate the mechanisms after visualizing the geometry and operation within the interface 300. Here, the prompt transformer 240 outputs the friction-based mechanism combined with the shape-shifting mechanism. The output triggers another idea for securing the racks through incorporating the adhesion mechanism of parasitic copecods, such as microridges and channels for increasing friction upon contact.

Another design task may be improving collision resistance for racing cars. Here, the core challenge can be compression management during a collision. The design system 100 receives a query for managing collision as a design task and outputs a solution cluster having biological mechanisms that are analogical. For example, the solution cluster includes “interlocking barbules for structural integrity during flight” for feathers and “pressure management in segmented skeletons” in isopods. Here, these mechanisms employ different and diverse approaches to compression management. As such, a combine function generates design ideas that benefit from both mechanisms. The combined output describes an approach that applies interlocking structures to exoskeleton segments that can be a “sliding-lock” mechanism for modular panels associated with a vehicle body. Therefore, this mechanism allows for extensive compression upon collision, thus increasing impact time, decreasing peak force, and more effectively dissipating force to body components that are non-critical.

As previously explained, the generation module 130 can generate mechanisms and corresponding species in batches. For instance, the design system 100 receives five problems for vehicle design: managing impact, managing tension, managing compression, managing turbulence, and modifying speed. The design system 100 indexes relevant species upon appearance in the corresponding mechanism generation. Hence, the index corresponds to when a new mechanism was generated. At a generation index, the design system 100 counts unique names that are generated up to a point for a taxonomic node and average the numbers across the five problems. Furthermore, the design system 100 can qualitatively observe that the species generated are monotonically increasing but at a decreasing rate. As another parameter, a ratio between unique species and the generation index can suggest more mechanisms are generated and become concentrated on individual species as generation continues. For example, the design system 100 concentrates on grasshoppers since they have several mechanisms that are distinct and relevant to managing turbulence, such as foldable wings, lightweight exoskeletons, joints enabling repeated jumps, etc. Regarding quantitative analysis, measuring the slope of the generation index can indicate organism diversity.

Additionally, understanding frame slipping can improve analogical transfer for generated mechanisms. Re-structuring concerns conceptual frames that successfully “slip” into a new and analogous problem domain that causes structural changes in the conceptual framework of the receiving domain. For example, a playground slide can “slip” into a swing set through semantic relationships and consequently generate a design for a swing chair of an infant. Frame slips imply that transitions can occur through different relational paths, such as syntactic, semantic, functional, abstracted commonality, geometric, etc. paths. While geometric transfer can be a concrete form of transformation onto the transfer process, other transfers can involve multimodal processes that combine multiple relational paths. Therefore, the design system 100 integrating frame slipping into mechanism generation can open creative spaces previously unexplored.

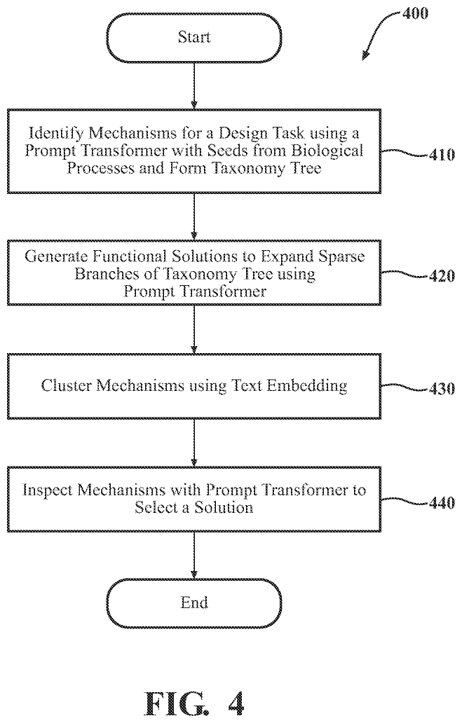

Now turning to FIG. 4, a flowchart of a method 400 that is associated with identifying mechanisms for a design task within a taxonomical framework and generating mechanisms that can be functional solutions that expand sparse branches using a prompt transformer is illustrated. Method 400 will be discussed from the perspective of the design system 100 of FIG. 1. While method 400 is discussed in combination with the design system 100, it should be appreciated that the method 400 is not limited to being implemented within the design system 100 but is instead one example of a system that may implement the method 400.

At 410, the design system 100 identifies mechanisms for a design task using a prompt transformer (e.g., GPT-3.5, GPT-4, etc.) with seeds from biological processes and forms a taxonomy tree. Here, the design system 100 can identify mechanisms for the design task by invoking a prompt transformer with seeds representing biological processes. Initially, the prompt transformer forms the taxonomy tree from the mechanisms according to the seeds. For example, the prompt transformer acquires and structures data from human experts (e.g., AskNature information) that is raw into problem-mechanism schemas. This data can be curated information about organisms with detailed descriptions of unique strategies to functional problems (e.g., manage impact, modify speed, etc.). The design system 100 may predict a functional problem p that is relevant to a design domain and curate the seeds with quality mechanisms.

As previously explained, in one approach, the design system 100 searches the sub-list of organisms o∈O and strategies to p from human experts by parsing web code and accessing data for an organism-strategy. Furthermore, the design system 100 organizes the unstructured and raw text into a mechanism description using the prompt transformer. For example, the prompt transformer selects a functional problem from the biological processes associated with the design task, accesses a subset of organisms associated with the functional problem, and structures the subset by textually describing the mechanisms. Additionally, the prompt transformer can compactly describe an identified mechanism of a data pair (o, p) having raw text and missing information related to the design task. In another approach, the prompt transformer outputs a mechanism description when having complete information from the human experts with input (o, p, Experts(o, p)). The mechanism description m outputted along with the function description may also be a problem-mechanism schema for an organism: {o∈O|(p, m, o)} when involving incomplete information.

At 420, the generation module 130 generates functional solutions to expand sparse branches of the taxonomy tree for the mechanisms using the prompt transformer. Here, the design system 100 can traverse the taxonomy tree for adding a new genus and augmenting an existing genus at the sparse branches for the design task. As previously explained, in one embodiment, the design system 100 iteratively invokes the prompt transformer to identify and generate relevant mechanisms for an inputted mechanism and problem using seeds from expertly-curated data. The taxonomy tree can expand by mixing breadth-focused and depth-focused strategies. A breadth-focused expansion may comprise extracting sibling taxonomies with a new genus for the design task. A depth-focused expansion may comprise adding child taxonomies on an existing genus.

Moreover, extracted taxonomies for an expansion strategy may be appended to prompts as constraints. In one approach, the expansion strategy follows a hierarchy from nature: {domain, kingdom, phylum, class, order, family, genus, species}. Here, a domain represents the highest level and a species represents the lowest level within the taxonomic tree. As further optimization, the design system 100 can cut and trim the taxonomy tree at a level (e.g., class) for expansion and sort taxonomies on a level by children nodes following an increasing order.

At 430, the design system 100 clusters mechanisms using text embedding. Clustering can involve the design system 100 converting text strings describing the mechanisms within the taxonomy tree to numerical vectors. For instance, a model for the text embedding converts the text strings. In this way, the design system 100 can compare and derive semantic relationships associated with the mechanisms with the numerical vectors. Furthermore, clustering may include the design system 100 deriving word frequency associated with the mechanisms. For example, the design system 100 counts the frequency of a word and selects the most frequent words as a cluster description. In this way, clustering provides a diverse look at mechanisms for design and increases organization.

At 440, a designer inspects the mechanisms with the prompt transformer to select a solution. Here, the design system 100 generates an interface having outputs from the prompt transformers that may describe biological processes analogous to the design task. Furthermore, the interface allows the designer to perform interactive functions with the outputs, such as explain, compare, combine, and critique functions. For example, the design system 100 receives a request to revise the mechanisms and revises the mechanisms through selective combinations according to functional similarities. In one approach, the design system 100 combines mechanisms through integrating similar geometries and problem-mechanism relationships between the mechanisms and the design task. Therefore, the design system improves creativity and diversity for the design task with the prompt transformer through identifying, generating, and adapting mechanisms from natural processes.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A design system comprising:
a memory storing instructions that, when executed by a processor, cause the processor to:
identify mechanisms for a design task using a prompt transformer with seeds from biological processes, and the prompt transformer forms a taxonomy tree using the mechanisms;
generate functional solutions that expand sparse branches of the taxonomy tree for the mechanisms using the prompt transformer;
cluster the mechanisms using text embedding for the design task; and
inspect the mechanisms with the prompt transformer to select a solution associated with the design task.

2. The design system of claim 1, wherein the instructions to generate the functional solutions further include instructions to traverse the taxonomy tree by the prompt transformer to add a new genus and augment an existing genus with species at the sparse branches for the design task according to the seeds.

3. The design system of claim 2, wherein the instructions to traverse the taxonomy tree further include instructions to:
increase the mechanisms by the prompt transformer within a section of the taxonomy tree for the new genus using a first prompt;
expand the mechanisms by the prompt transformer outside the section of the taxonomy tree for the existing genus using a second prompt; and
structure the mechanisms by a learning model into a data pair of the functional solutions and organisms within the taxonomy tree.

4. The design system of claim 1, wherein the instructions to identify the mechanisms further include instructions to:
select a functional problem by the prompt transformer from the biological processes associated with the design task;
access a subset of organisms associated with the functional problem; and
structure the subset using the prompt transformer by textually describing the mechanisms.

5. The design system of claim 4, wherein a problem schema includes the subset, the functional problem, and one of the mechanisms.

6. The design system of claim 1, wherein the instructions to cluster the mechanisms further include instructions to:
convert text strings associated with the mechanisms to numerical vectors; and
compare the numerical vectors to derive semantic relationships and word frequency associated with the mechanisms.

7. The design system of claim 1 further including instructions to:
render an interface that displays textual explanations and visual representations of the mechanisms;
receive by the prompt transformer a request to revise the mechanisms from the interface; and
revise the mechanisms by the prompt transformer through selective combinations according to functional similarities.

8. The design system of claim 1, wherein the design task is an engineering problem and the seeds have functional characteristics and aesthetic characteristics that are analogical.

9. The design system of claim 1, wherein the seeds are data pairs having organisms and the biological processes that are expertly-curated and the prompt transformer is a large language model (LLM) that interprets the data pairs.

10. A non-transitory computer-readable medium comprising:
instructions that when executed by a processor cause the processor to:
identify mechanisms for a design task using a prompt transformer with seeds from biological processes, and the prompt transformer forms a taxonomy tree using the mechanisms;
generate functional solutions that expand sparse branches of the taxonomy tree for the mechanisms using the prompt transformer;
cluster the mechanisms using text embedding for the design task; and
inspect the mechanisms with the prompt transformer to select a solution associated with the design task.

11. The non-transitory computer-readable medium of claim 10, wherein the instructions to generate the functional solutions further include instructions to traverse the taxonomy tree by the prompt transformer to add a new genus and augment an existing genus at the sparse branches for the design task according to the seeds.

12. A method comprising:
identifying mechanisms for a design task using a prompt transformer with seeds from biological processes, and the prompt transformer forms a taxonomy tree using the mechanisms;
generating functional solutions that expand sparse branches of the taxonomy tree for the mechanisms using the prompt transformer;
clustering the mechanisms using text embedding for the design task; and
inspecting the mechanisms with the prompt transformer to select a solution associated with the design task.

13. The method of claim 12, wherein generating the functional solutions further includes traversing the taxonomy tree by the prompt transformer to add a new genus and augmenting an existing genus at the sparse branches for the design task according to the seeds.

14. The method of claim 13, wherein traversing the taxonomy tree further includes:
increasing the mechanisms by the prompt transformer within a section of the taxonomy tree for the new genus using a first prompt;
expanding the mechanisms by the prompt transformer outside the section of the taxonomy tree for the existing genus using a second prompt; and
structuring the mechanisms by a learning model into a data pair of functions and organisms within the taxonomy tree.

15. The method of claim 12, wherein identifying the mechanisms further includes:
selecting a functional problem by the prompt transformer from the biological processes associated with the design task;
accessing a subset of organisms associated with the functional problem; and
structuring the subset using the prompt transformer by textually describing the mechanisms.

16. The method of claim 15, wherein a problem schema includes the subset, the functional problem, and one of the mechanisms.

17. The method of claim 12, wherein clustering the mechanisms further includes:
converting text strings associated with the mechanisms to numerical vectors; and
comparing the numerical vectors to derive semantic relationships and word frequency associated with the mechanisms.

18. The method of claim 12 further comprising:
rendering an interface that displays textual explanations and visual representations of the mechanisms;
receiving by the prompt transformer a request to revise the mechanisms from the interface; and
revising the mechanisms by the prompt transformer through selective combinations according to functional similarities.

19. The method of claim 12, wherein the design task is an engineering problem and the seeds have functional characteristics and aesthetic characteristics that are analogical.

20. The method of claim 12, wherein the seeds are data pairs having organisms and the biological processes that are expertly-curated and the prompt transformer is a large language model (LLM) that interprets the data pairs.
